(19) United States
(12) Patent Application Publication
(10) Pub. No.: US 2004/0145615 A1
(43) Pub. Date: Jul. 29, 2004

(54) Printing/scanning device entitlement monitoring system

(76) Inventors: Eugene Villa Castro, Meridian, ID (US); Terry Ryan Jamison, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/353,313

(22) Filed: Jan. 29, 2003

(51) Int. Cl. B41J 29/38

(52) U.S. Cl. 347/14

(57) ABSTRACT

A method and system for providing entitlement information to a printing device or a scanning device are described. The system includes a device, a device workstation, which in an implementation is a constituent of the device, and a server. The server maintains a database of updated device entitlement information associated with the device. The workstation requests updated entitlement information for the device from the server, and the server in response downloads this information to the workstation. The workstation downloads the updated entitlement information to a device database. In embodiments, both the device and the workstation provide notification to a user of updated entitlement information, and display updated entitlement information to the user.

### TECHNICAL FIELD

This invention relates generally to printing device systems and scanning device systems, and more particularly but not exclusively, to methods and systems that provide current entitlement information on a printing device system and on a scanning device system.

### BACKGROUND

The usage and deployment of printing devices and scanning devices have become ubiquitous. They are at the home, the office, and nearly all commercial establishments. Printing devices and scanning devices are typically sold with entitlement information such as warranty and contact information. This information is often in the form of paper documents, which are filed separately from the devices for future reference. Unfortunately, because the entitlement information is often not needed until some later time, it can be forgotten, misplaced, or otherwise can be not easily findable. Moreover, because the entitlement information is often filed away, the user is not aware when this information is to expire. And moreover, the user is often not aware of updates to this entitlement information.

### SUMMARY

A method, and a system for providing updated entitlement information for a device characterized as a printing device or a scanning device, to the device, and the host computer, is described. Briefly, but not exclusively, the system includes a printing device or a scanning device, a device workstation which in an implementation is a host computer, and a server. The server maintains a database of updated entitlement information including device maintenance and contract information associated with the device. Automatically, or upon user request, the workstation requests the updated entitlement information for the device from the server, and the server, in response, downloads this information to the workstation. The workstation downloads the updated entitlement information to a device database. In this manner, both the device and the workstation are capable of notifying a user of updated entitlement information, and display the updated entitlement information to the user.

### BRIEF DESCRIPTION OF THE DRAWINGS

FIG. 1 portrays a block diagram of an exemplary printing device entitlement information monitoring system.

FIG. 2 is a flow chart of an exemplary implementation of a method of maintaining updated entitlement information in a server database.

FIGS. 3A-3B is a flow chart of an exemplary implementation of a method of initializing a workstation computer and printing device with entitlement information from a server 104.

FIGS. 4A-4C is a flow chart of an exemplary implementation of a method of automatically monitor an entitlement information server for entitlement updates, and updating a workstation computer and printing device with those updates.

FIG. 5 is a flow chart of an exemplary implementation of a human operator initiated updating of a workstation computer and a printing device with entitlement information from a server.

FIGS. 6A-6B is a flow chart of an exemplary implementation of a method of a human operator initiated updating a printing device with workstation computer entitlement information, viewing entitlement information, and receiving specific entitlement information notifications.

### DETAILED DESCRIPTION

The following describes an architecture and a method for maintaining up-to-date entitlement information for both printing devices and scanning devices. The architecture facilitates transfer of this information to individual printing devices or computers connected thereto, to make the information readily available to the user.

Throughout this description, the term “entitlement” information is used. Entitlement information includes warranty and contract information associated with a printing device or a scanning device. Printing device and scanning device entitlement information can include the specific terms of an existing warranty and maintenance contract. The specific terms can include illustratively warranty and maintenance contract start and expiration dates, the updated warranty and maintenance contract identification numbers, the current name of the registered owner of the printing device/scanning device, and the relevant part numbers. Printing device and scanning device entitlement information can include also the related support information associated with a printing device or a scanning device. The related support information can include illustratively the maintenance support telephone number(s); the maintenance support internet sites, such as where to go to purchase or update the maintenance contract and the warranty, and where to obtain the warranty and the maintenance contract support; the printing device/scanning device purchase date, the information about available support packages; the time remaining on each entitlement; and the telephone numbers and prices for renewing or obtaining a support package or other entitlement.

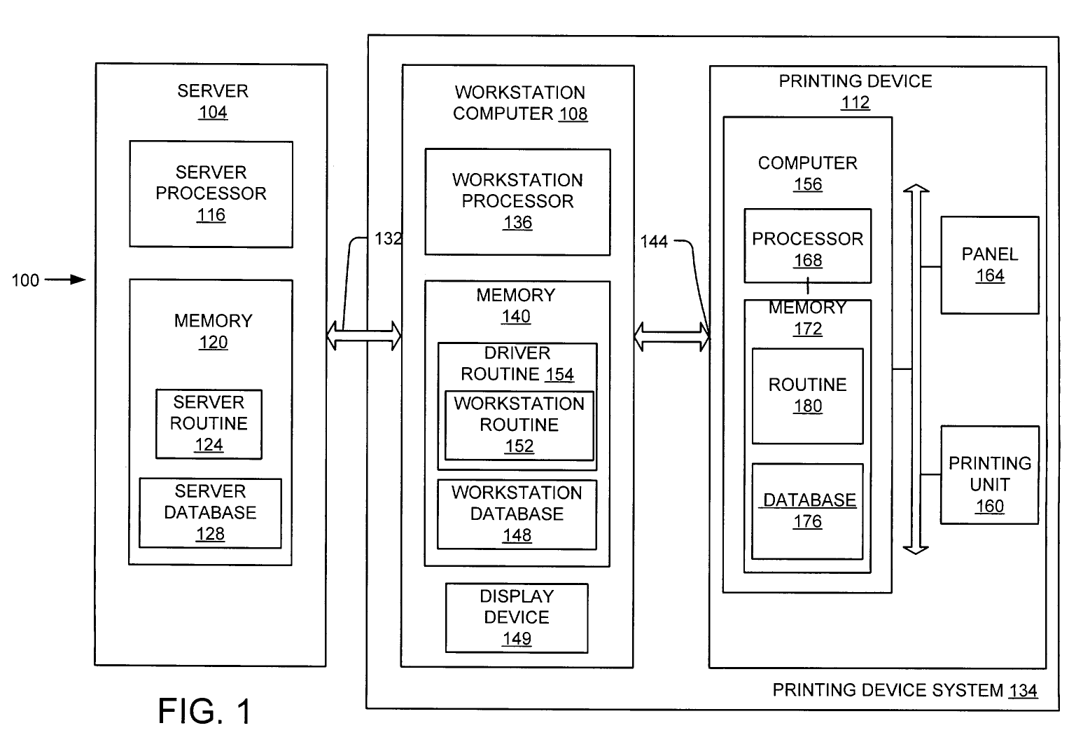

FIG. 1 shows an exemplary printing device entitlement information monitoring system 100 that includes a server 104, a printing device workstation computer 108, and a printing device 112.

The server 104 includes a server processor 116, and a memory 120 that stores a server routine 124, and a server database 128. The server database 128 stores entitlement information for printing devices. The server 104 is coupled to the workstation computer 108 via a network 132, such as the Internet or a local area network. The network may be implemented using wire-based or wireless technologies, or a combination of the two.

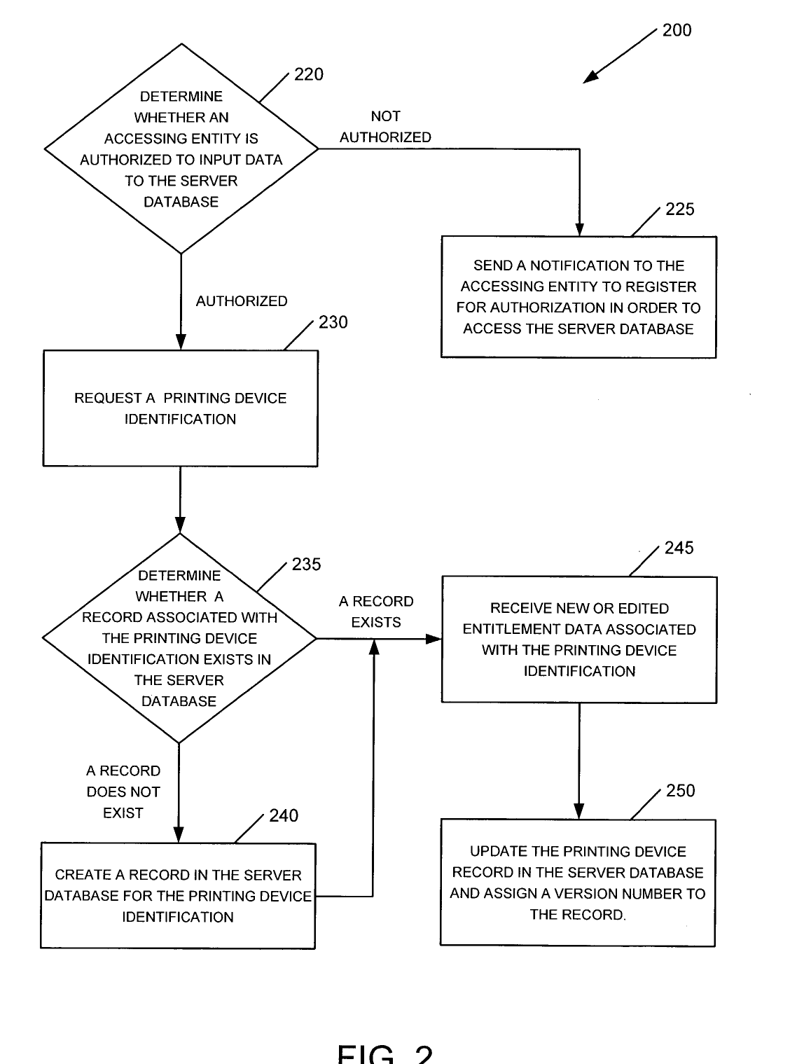

The server processor 116 is configured to execute the server routine 124 to cause the server 104 to perform the processes described here, and portrayed and described with reference to FIGS. 2-6. The server 104 downloads printing device entitlement information to the workstation computer 108. The printing device entitlement information is associated with a specified printing device. The server 104 downloads the printing device entitlement information in response to a request by the workstation computer 108. The server 104 maintains the server database 128. In an implementation, the server database 128 is updated by an authorized entity, such as a selling entity. The server database 128 provides up-to-date entitlement information to both the workstation computer 108 and the printing device 112, to enable the workstation computer 108 and the printing device 112 to store updated entitlement information, and to manipulate that data for display on the workstation computer 108 and the printing device 112. An exemplary implementation of the operation of the server 104 to maintain the server database 128 is portrayed and described with reference to FIG. 2.

The implementation described herein of the printing device workstation computer 108 is of a separate host computer coupled to the printing device 112. As a separate computer, the workstation computer 108 is coupled to the printing device 112 typically through a conventional printer cable port 144, such as at present time, a Universal Serial Bus (USB) port, a parallel printer bus port, a serial printer bus port, or a network bus port. The port 144 transmits both entitlement information between the workstation computer 108 and the printing device 112, and conventional printing data for printing a page(s), for between the workstation computer 108 and the printing device 112. In another implementation of the workstation computer 108, the workstation computer 108 is a constituent of the printing device 112, and not a separate computer. As a constituent of the printing device 112, the workstation computer 108 and the printing device processor together may share a common processing device. In the implementation of the workstation computer 108 as a constituent of the printing device 112, the workstation memory 140 and the printing device memory together may share a common memory device. The workstation computer 108, and the printing device 112, together constitute a printing device system 134.

The workstation computer 108 includes a workstation processor 136 and a workstation memory 140. The workstation memory 140 stores both a workstation database 148, and a workstation routine 152. The workstation database 148 stores printing device entitlement information downloaded from the server 104. In one implementation, the workstation routine 152 is installed by a user as a part of the printing device driver, and forms a constituent of a printing device driver routine 154 that includes the workstation routine 152.

The workstation processor 136 is configured to execute the workstation routine 152, to cause the workstation computer 108 to perform the processes described here. The workstation computer 108 may request both manually and/or automatically (depending upon user selection) updated entitlement information from the server 104. The workstation computer 108 writes the received entitlement information into the workstation database 148. The workstation computer 108 downloads entitlement information for a specific printing device to that printing device. The workstation computer 108, upon user authorization, provides alerts to indicate whether an entitlement for a printing device is to expire, at times selected by the user. The workstation computer 108 generates data representing an expiration alert, and transmits the data to a coupled display device 149 for display of an entitlement expiration notification. The workstation computer generates data representing an expiration alert, and transmits the alert to the printing device 112, for display or printing of an expiration notification on the printing device 112. The workstation computer 108 generates entitlement information for display on the display device 149, and/or downloads the information for display or printing on the printing device 112. The workstation computer 108 generates a notification if the entitlement information for a printing device 112 has been updated. The operations of the executing workstation routine 149 are portrayed and described in greater detail with reference to FIGS. 2A-2F.

The printing device 112 includes a printing device computer 156 coupled to both a printing unit 160, and a panel 164. The printing device computer 156 includes at least one printing device processor 168, and one printing device memory 172.

The printing device memory 172 stores a printing device database 176. The database 176 stores data that represents printing device entitlement information to be read and written to by the processor 168. The database 176 data is to be selectively output by the processor 168 to the panel 164 for display (enunciation) on the panel 164, and/or the printing device printing unit 160 for printing on the printing device 112.

The printing device memory 172 stores a printing device routine 180 having instructions to be executed by the printing device processor 168. The printing device processor 168 is configured to execute the printing device routine 180, to cause the printing device computer 156 to perform the processes described here. The printing device computer 156 receives downloaded entitlement information from the workstation computer 108, and writes the entitlement information into the database 176. The printing device computer reads the database 176 and displays (enunciates) the database data on the panel 164 and/or transmits it to the printing unit 160 to be printed on a sheet of pages. The printing device computer 156 receives notifications from the workstation computer 108, such as an entitlement expiration alert, or an entitlement information update notification, and causes the information to be displayed on the panel 164, or printed by the printing unit 160. The printing device computer 156 reads user inputs from the panel 164 relating to entitlement information requests on the printing device 112, and responds to the requests to cause entitlement information to be displayed on the panel 164 or printed by the printing unit 160. Before entitlement information that is downloaded from the workstation computer 108, or read from the database 176, is displayed on the panel 164, or printed by the printing unit 160, the printing device computer 156 information may transform the information to be suitable for displaying or printing.

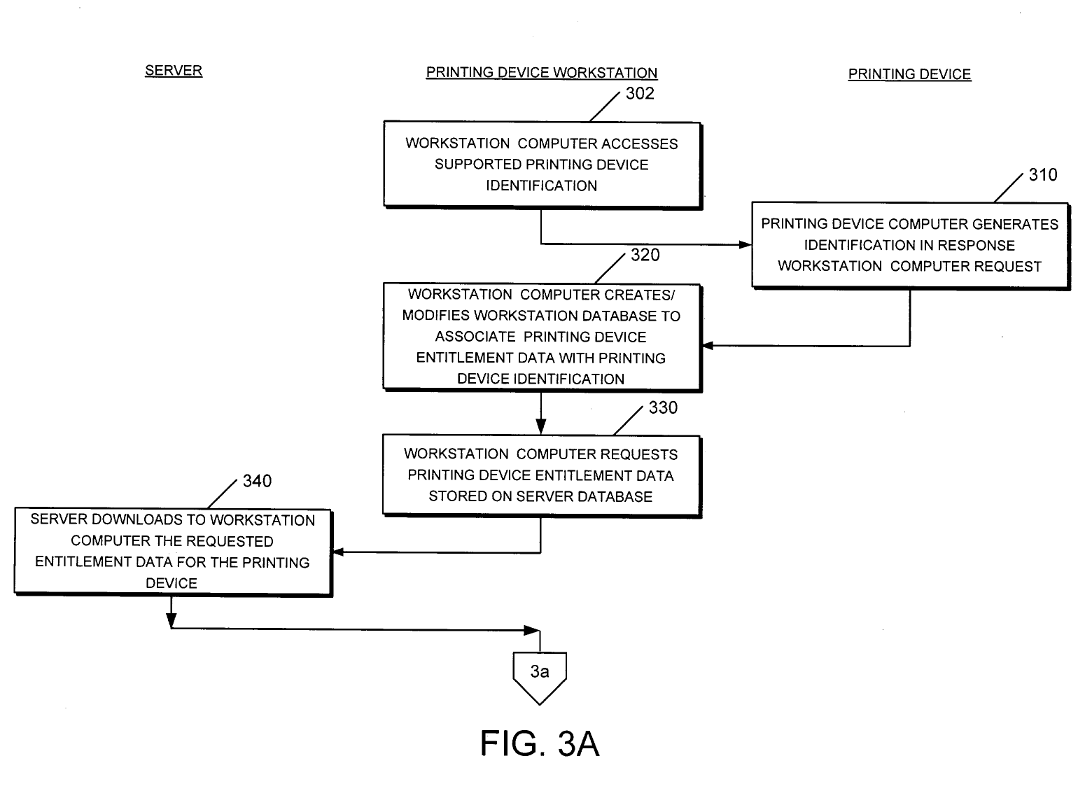

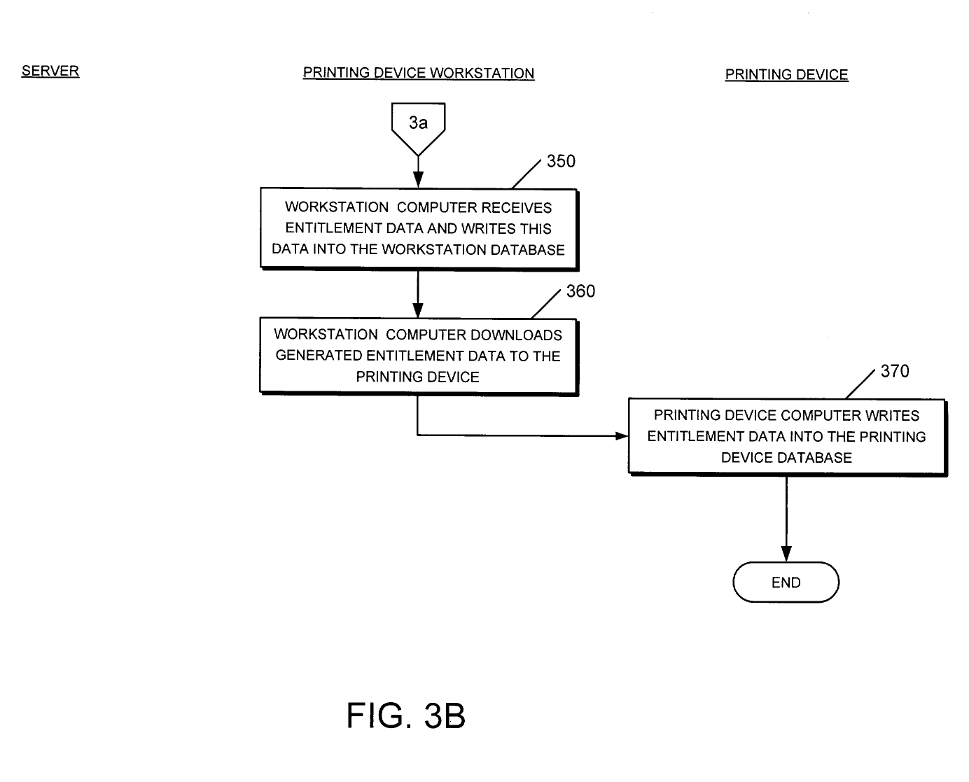

The content and operation of both the printing device computer 156, the printing device routine 180, and the printing device database 176, are described below with reference to FIGS. 3-6.

Both the printing device database 176, and the printing device routine 180, or representations thereof (such as a compressed representation), can be stored on a non-volatile type of memory in the printing device memory 172, and are therefore sometimes referred to as the printing device firmware. Because the printing device database 176 and the printing device routine 180 are stored on a non-volatile memory, they will not be lost when the printing device 112 power supply is removed. In an implementation, the printing device database 176 and/or the printing device routine 180, can be downloaded and stored for execution of the printing device routine 120, on a non-volatile RAM of the memory 172.

The printing device panel 164 includes a medium to display entitlement information, such as in an implementation, a light emitting diode (LED) or other indicator (enunciator) to indicate by illumination binary entitlement information that is generated by the processor 168, or in an implementation, a display panel to display alphanumeric or graphical entitlement information that is generated by the processor 168. In an implementation, the printing device panel 164 includes a switch to indicate to the processor 168 maintenance information monitoring system functions to be executed by the processor 164.

The printing device printer unit 160 is to print information on a medium such as a sheet. The processor 168, in response to the routine 180, generates selected entitlement information, and outputs the selected entitlement information to the printing unit 160, to print the selected entitlement information.

FIG. 2 portrays an exemplary process 200 to maintain and update the entitlement information at the server 108, where authorized entities are permitted to submit information to the server 108, update the server database 128. Illustratively, a manufacturer or a licensed vendor of a printing device may wish to provide additional or updated information pertaining to maintenance schedules and the like, and will enter into the process 200 described herein. The process 200 is described as being performed by the server 150 executing a routine 154.

In block 220, an entity attempting to access the server database 128, to input or edit (modify) a record associated with a printing device, transmits an identification to the server 104. The server 104 determines whether the entity is authorized, or not authorized, to input or edit a server database record based on the input entity identification. In block 225, if the entity is not authorized to input or edit a server database record (the “NOT AUTHORIZED” branch in block 220), then the server 104 sends a notification to the entity to register for authorization to input or edit a server database record.

In block 230, if the entity is authorized to input or edit a server database record (the “AUTHORIZED” branch in block 220), the server 104 requests the entity to submit a printing device identification. The server 104 then waits for the accessing entity to send a printing device identification. In block 235, upon receiving a printing device identification from the accessing entity, the server 104 reads the input, and determines whether there is a record in the server database 128 that is associated with the printing device identification.

In block 240, if there is not a record in the server database 128 associated with the printing device identification (the “A RECORD DOES NOT EXIST” branch in block 235), then the sever 104 creates a record in the server database 128 for the printing device 112.

In block 245, if there is a record in the server database 128 associated with the printing device identification (the “A RECORD DOES EXIST” branch in block 235), or after the server 104 creates a record in the server database 128 in block 240, then the accessing entity inputs new or changed entitlement information associated with the printing device identification into the server 104. The server 104 reads this information. In block 250, the server 104 updates the printing device record in the server database 128, based on the entitlement information input in block 245 by the accessing entity. The server 104 may also assign the record a version number.

Multiple entities can update entitlement information on the server 104 for multiple printing devices. In this manner, the server 108 is able to maintain updated records.

FIGS. 3-6 portray functions of both the workstation computer 108 in responding to the instructions of an exemplary implementation of the workstation routine 152, the printing device computer 156 in responding to the instructions of an exemplary implementation of the printing device routine 180, and the server 104 in responding to the instructions of an exemplary implementation of the server routine 124. In the following description referenced to FIGS. 3-6, the actions attributed to the workstation computer 108 is the workstation computer 108 responding to the instructions of an executing workstation routine 152, the actions attributed to the printing device computer 156 is the printing device computer 156 responding to the instructions of an executing printing device routine 180, and the actions attributed to the server 104 is the server 104 responding to the instructions of an executing server routine 124.

FIGS. 3A-3B portray an exemplary process to initialize or modify the workstation computer 108 and the printing device 112 with entitlement information from the server 104. This initialization/modification is based on a unique printing device identifier. Referring to FIGS. 3A-3B, upon successful initial installation of the driver routine 154 in the workstation computer 108, in block 302, the workstation computer 108 communicates with the printing device computer 150 to obtain an identification of the printing device 112. In block 310, the printing device computer 156 generates the printer identification from a stored printer identification in the printing device database 176. Generally, the printer identification will include the printing device model number and the printing device serial number, that together uniquely identify the printing device 112. In an implementation, the printer identification is a Globally Unique Identifier (GUID), or some other data that uniquely identifies the printing device 112. Alternatively in an implementation, a human operator can input the printing device identification directly into the workstation computer 108, through a computer input device such as a keyboard, in response to a prompting by the workstation computer 108. In block 320, the workstation computer 108 creates or updates its database 148 to include the printing device entitlement information and to associate the printing device entitlement information with the printing device identification.

In blocks 330-350, the workstation computer 108 updates its database 148 with the most recent entitlement information that is stored on the server 104 for the printing device 112. The update described with reference to blocks 330-350 is an initial update that may be performed during an initial download of entitlement information from the server 104 to the workstation 108, for a specific printing device. In block 330, the workstation computer 108 communicates with the server 104, and requests the entitlement information stored on the server database 128 that is associated with the printing device 112, identified by the printing device identification. This communication to the server 104 may be automatic or in response to input from a human operator.

In block 340, the server 104 downloads to the workstation computer 108, the entitlement information associated with the printing device 112 and stored in the server database 128. In block 350, the workstation computer 108 receives the entitlement information associated with the printing device identification from the server 104, and writes this information into the workstation database 148, associated with the specific printer identification.

In block 360, the workstation computer 108 downloads workstation database 148 data to the printing device 112, via the printer port 144 to update the printing device database 176. In an implementation, before the workstation computer 108 downloads the workstation entitlement data from the workstation database 148 to the printing device 112, the workstation computer 108 generates a display message to indicate to a user that the workstation computer 108 has received updated entitlement information, which can be downloaded to the printing device computer 158. The workstation computer 108 downloads the entitlement information if a human operator authorizes that the information be downloaded into the printing device computer 156. In block 370, the printing device computer 156 receives from the workstation computer 108, the downloaded entitlement information, and writes this information into the printing device database 176.

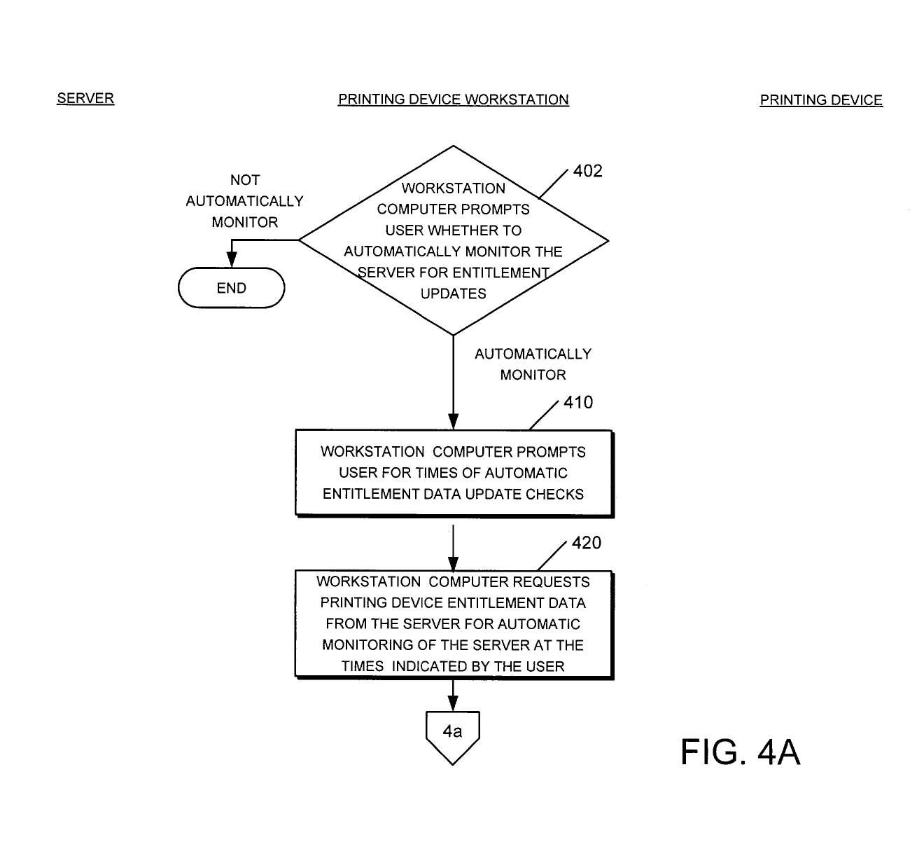

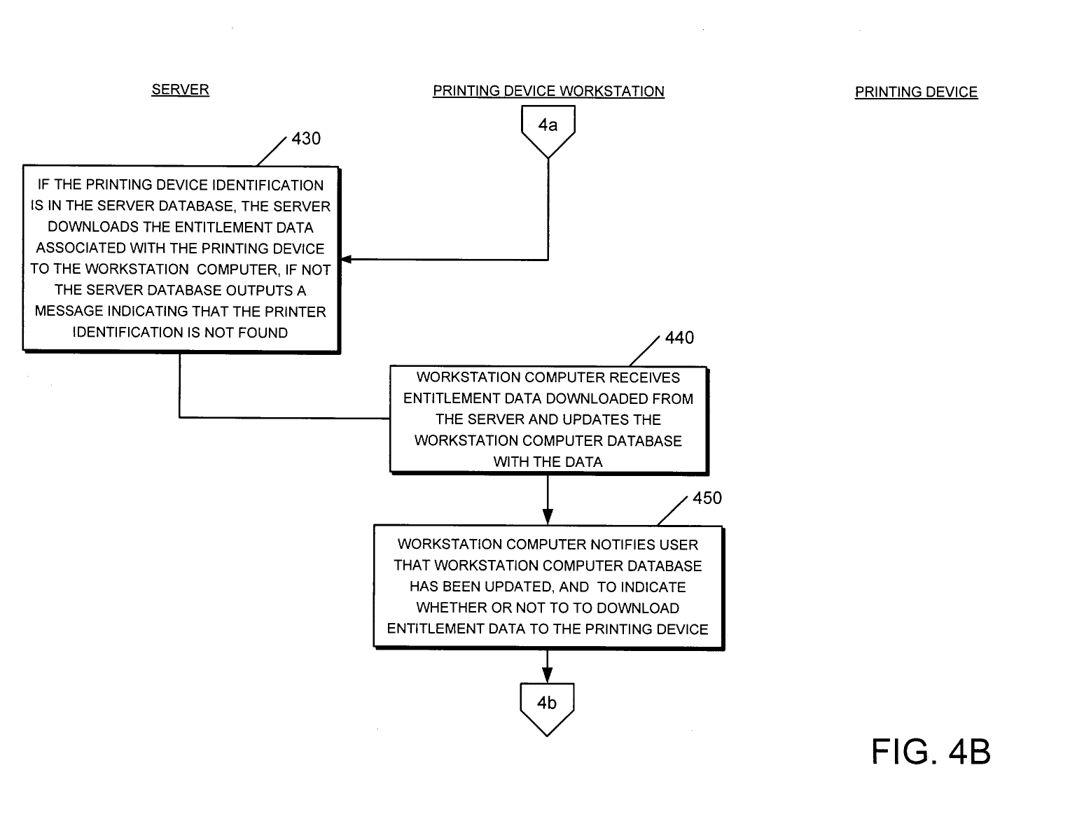

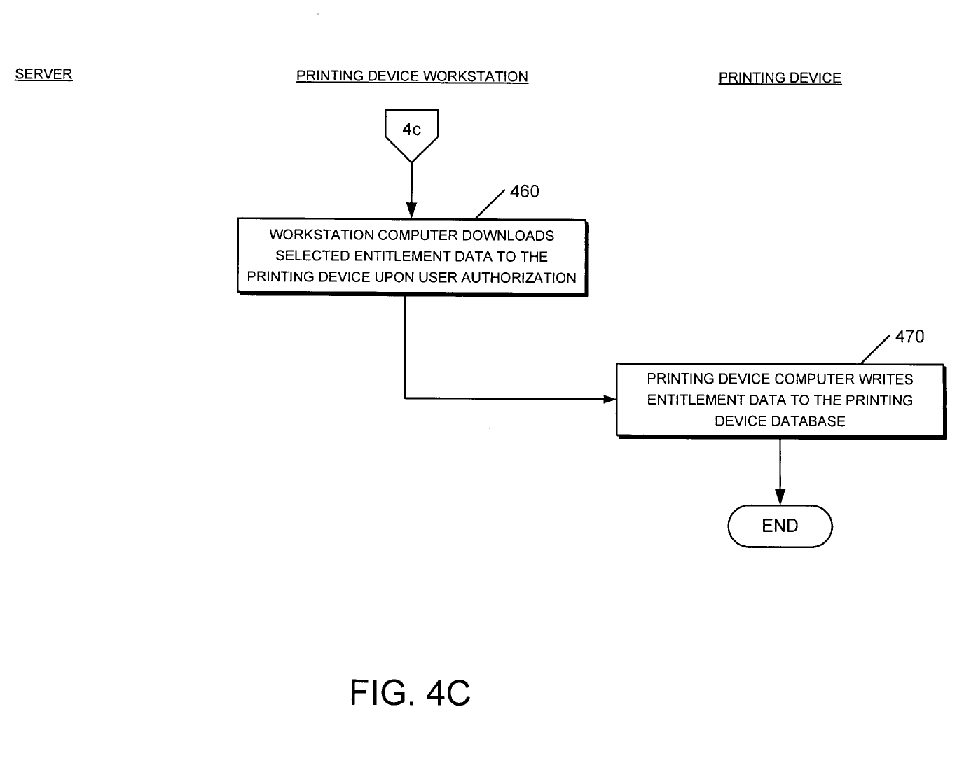

FIGS. 4A-4C portray an exemplary process for the workstation computer 108 to automatically monitor the server 104 for entitlement updates, and to update the workstation computer 108 and the printing device 112 with those updates. Referring to FIGS. 4A-4C, in blocks 402-410, the workstation computer 108 determines whether to automatically monitor the server database 128 for changes in the stored entitlement information, and if so, the times to monitor the server database 128. In block 402, the workstation computer 108 prompts a human operator to select automatic or manual monitoring of the server database 128. The workstation computer 108 determines whether to automatically monitor the server database 128, based on the human operator selection. If the human operator selects automatic monitoring in block 218, then in block 410 the workstation computer 108 prompts the human operator to select the times at which to automatically monitor the server database 128.

In blocks 420-440, the workstation computer 108 automatically monitors the server database 128 for updates to the available entitlement information stored therein and associated with the printing device 112. In an implementation, the human operator is requested to select whether the human operator wants automatic monitoring for entitlement updates to the printing device 112, and if the human operator selects active monitoring, the human operator is then requested to select the monitoring frequency or time. In block 420, the host computer periodically automatically requests the server database 128 to download entitlement information associated with the printing device 112 at the selected time(s). In block 430, in response to the workstation computer 108 request in block 420, the server 104 downloads the entitlement information associated with the printing device 112 to the workstation computer 108. In block 440, the host computer receives the downloaded entitlement information associated with the printing device in block 430, and updates the workstation database 148 with the downloaded entitlement information.

In one implementation, if the entitlement information associated with a printing device has not been updated since the previous download of information from the server 104, then the server 104 does not send the entitlement information. Instead, the server 104 may send information indicating that the entitlement information has not been updated. As one way to determine whether the entitlement information on the server database 128 has been updated since the previous download, a version identifier is associated with each set of entitlement information. The server 104, or the workstation computer 108, compares the version identifier of the entitlement information stored in the server database 128 (say a “first” version identifier), with the version identifier for the entitlement information previously downloaded from the server 104 to the workstation computer 108 (say a second version identifier). If the version identifiers are different, then the entitlement information in the server database 128 has been updated since the previous download. If the version identifiers (that is the “first” version identifier and the “second” version identifier) are the same, then the information associated with the printing device in the server database 128 has not been updated.

The workstation computer 108 provides entitlement information both for download to the printing device computer 110, and for display on the display device 149 coupled to the workstation computer 108. In block 450, the workstation computer 108 provides a notification to a human operator indicating availability of updated entitlement information at the workstation 108 for the printing device 112. The notification is generated illustratively by way of the display device 149, or the panel 164. The workstation computer 108 generates a request for an authorization to download the updated entitlement information to the printing device 112. If the human operator indicates that the entitlement information should be downloaded to the printing device database 176, then in block 460 the workstation computer 108 downloads the selected workstation computer database information associated with the printing device 112. In block 470, the printing device computer 156 writes the downloaded data to the printing device database 176.

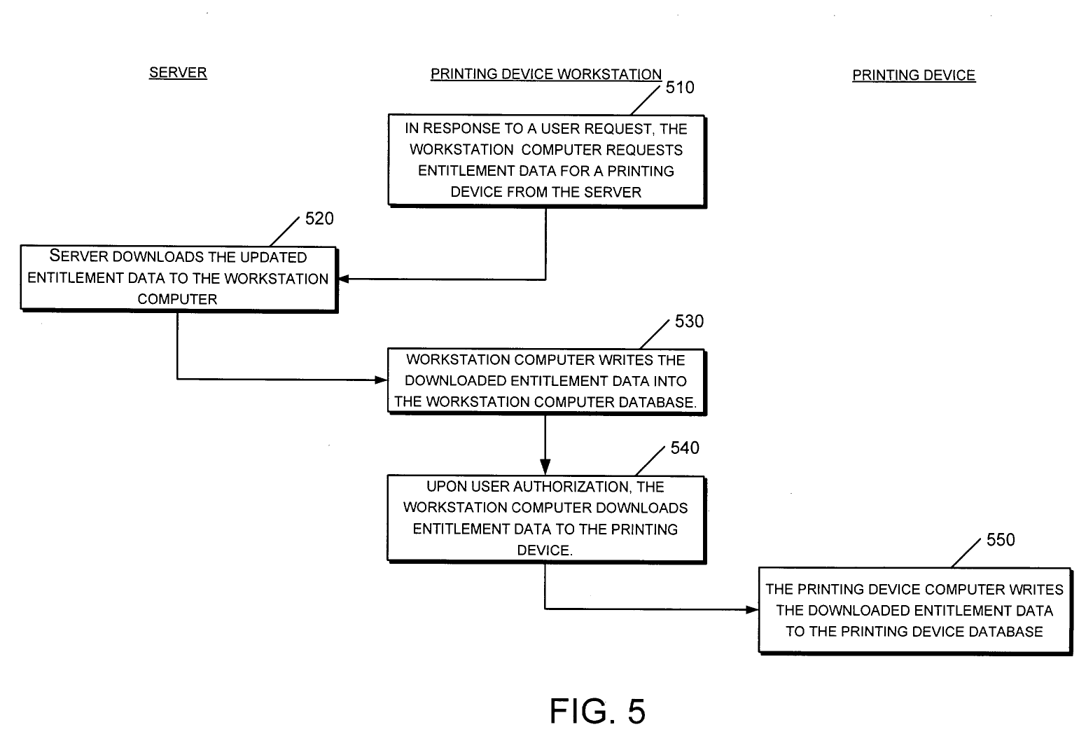

FIG. 5 portrays an exemplary process for a human operator initiated updating of the workstation computer 108 and the printing device 112 entitlement information with server 104 entitlement information. Referring to FIG. 5. At any time, a human operator can request and obtain current entitlement information for a printing device 112. In operation, this capability may be expected to be executed if the human operator has not requested automatic monitoring, and instead intends to rely on maintaining the currency of the workstation database 148 (and printing device database 176) by manually requested entitlement updates from the server 104. In block 510, in response to a human operator request, the workstation computer 108 requests entitlement information associated with the printing device identification from the server 104. In response, in block 520, the server 104 downloads from the server database 128 the entitlement information associated with the printing device 104 to the workstation computer 108. In block 530, the workstation computer 108 writes the downloaded entitlement information to the workstation database 148. Again, as described with reference to blocks 420-440, in an implementation the workstation computer 108 updates the workstation database 148 if the entitlement information on the server database 128 is updated since a previous download for the printing device 112. And again, as described with reference to blocks 220-440, in an implementation the server 104 downloads entitlement information if the information is updated since the last download for the printing device 112. In block 540, upon operator authorization the workstation computer 108 downloads entitlement information to the printing device 112 to be written to the printing device database 176. In block 550, the printing device computer 156 writes the downloaded entitlement information to the printing device database 176.

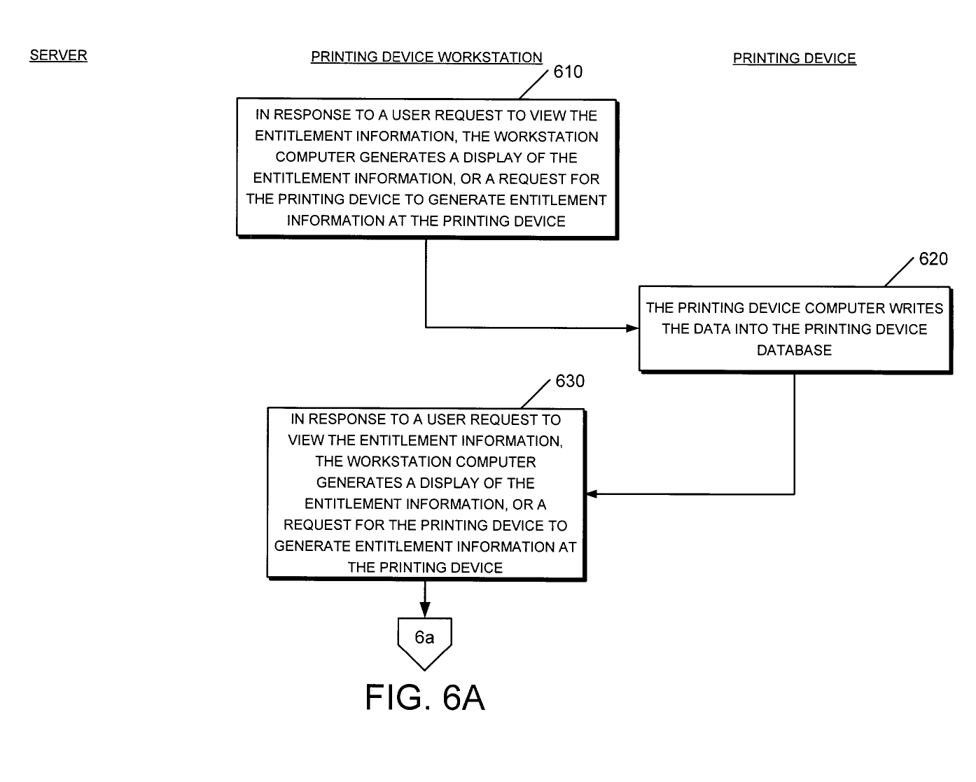

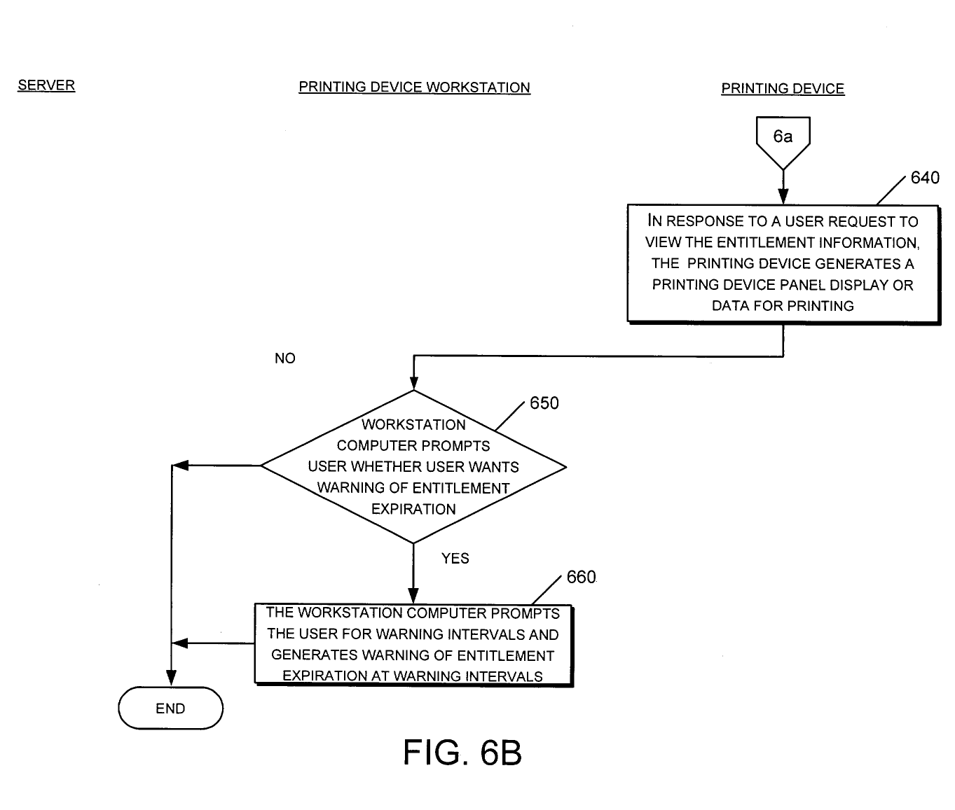

FIGS. 6A-6B portray an exemplary process for a human operator at any time to be able to update the printing device database 176 with workstation database 148 entitlement information, view entitlement information, and/or receive information regarding specific entitlement information notifications (such as an entitlement expiration notification). Referring to FIGS. 6A-6B, in block 610, the operator requests an update to the printing device database 176 by a request input into the workstation computer 108. In response to the request, the workstation computer 108 downloads entitlement information from the workstation database 148 to the printing device 112. In block 620, the printing device computer 156 writes the downloaded entitlement information into the printing device database 176.

At any time, a human operator can view the entitlement information for the printing device 112. In block 630, an operator indicates a request for entitlement information. The request can be input illustratively by way of the printing device panel 164, and/or the workstation computer 108 (e.g. a keyboard selection in response to a positioning of a cursor over a selection box). In response, the workstation computer 108 generates a display of the entitlement information, or a request directed at the printing device computer 156, to generate entitlement information at the printing device 112. Alternatively in block 640, in response to the operator request to view entitlement information, the printing device computer 156 generates a printing device panel display or data for printing from information downloaded for generation from the workstation computer 108. Alternatively, the printing device computer 156 generates a printing device panel display or data for printing from data downloaded for generation from the workstation computer 108 or read from the printing device database 176, in block 630.

A human operator can also request a notification of entitlement expiration. In block 640, the workstation computer 108 prompts the operator whether or not to request specific entitlement information notifications, illustratively a notice of entitlement expiration. In block 650, if the human operator requests a notice of entitlement expiration, the workstation computer 108 reads the workstation database 148 to determine when the entitlement(s) expire, and issues a notice at a requested time(s) to notify the human operator regarding entitlement expiration.

It is to be understood that the system is not limited in its application to the details or construction and the arrangements of components set forth in the following description or illustrated in the drawings. The system is capable of other implementations and of being practiced or being carried out in various ways. Specifically, while this invention has been described with reference to a printing device implementation, this invention includes any device having an embedded processor and a workstation computer as described herein, and specifically includes a scanning device.

Also, it is to be understood that the phraseology and terminology used herein is for the purpose of description and should not be regarded as limiting. The language in the patent claims may not capture every nuance of the printing device or describe with complete precision the range of its novelty. The scope is not limited to its literal terms but instead embraces all equivalents of the claims described. It is understood that the depicted acts in any described method are not necessarily order dependent, and in an implementation there may be intervening acts.

We claim:

1. A system, characterized as at least one of a printing device system and a scanning device system, comprising:
a processor;
a memory having stored thereon a routine and a database;
the routine including instructions that when executed by the processor, cause the processor to:
request device entitlement information from a server, the device characterized as at least one of a printing device and a scanning device;
receive the requested device entitlement information from the server;
write the received device entitlement information into the database; and
output the received device entitlement information to at least one of a computer display device; a panel of the device, and a printing device printing circuit.

2. The system recited in claim 1 wherein the request is an automatic request.

3. The system recited in claim 2 wherein the request is to receive updated entitlement information.

4. The system recited in claim 2 wherein the request is to receive entitlement information at times determined by a human operator.

5. The system recited in claim 1 wherein the request is in response to a human operator request.

6. The system recited in claim 1 wherein the instructions further cause the computer to output a notification to a human operator regarding an expiration of a device entitlement.

7. The system recited in claim 6 wherein the notification includes at least one of one of a printing device panel enunciation, a computer device display, and a printed sheet.

8. The system recited in claim 1 wherein the device entitlement information includes at least one of maintenance terms, warranty terms, maintenance contract expiration date, maintenance contract expiration date, available maintenance contracts, maintenance contact information, and warranty contact information.

9. The system recited in claim 1 wherein the output is in response to at least one of a human operator request and an update to the database.

10. A system comprising the system recited in claim 1 and the server.

11. A computer readable media having stored thereon a plurality of instructions that, when executed by a processor, cause the processor to perform acts that comprise:
accessing entitlement information for a device from a server, said device characterized as at least one of a printing device and a scanning device;
updating a database with the accessed entitlement information; and
outputting entitlement information from the database to an output medium.

12. The computer readable media recited in claim 11, wherein the acts further comprise receiving a device identification, and wherein the accessing includes transmitting to the server an identification based on the device identification.

13. The computer readable media recited in claim 11, wherein the outputting includes outputting entitlement information to the device.

14. The computer readable media recited in claim 11, wherein the accessing is automatic based on human operator determined times.

15. The computer readable media recited in claim 11, wherein the entitlement information includes at least one of maintenance terms, warranty terms, maintenance contract expiration date, maintenance contract expiration date, available maintenance contracts, maintenance contact information, and warranty contact information.

16. The computer readable media recited in claim 11, wherein the outputting is in response to at least one of a human operator request and an update to the database.

17. The computer readable media recited in claim 11, wherein the output medium includes at least one of a panel enunciator of the device, a computer device display; and a printed sheet.

18. The computer readable media recited in claim 11 wherein the acts further comprise outputting to an output medium, a notice of an entitlement expiration based on the content of the database.

19. The computer readable media recited in claim 11, wherein the acts further comprise sending to the printing device data representing an image to be printed by the printing device.

20. A device characterized as at least one of a printing device and a scanning device, the device comprising:
a processor;
a memory; and
a routine stored in the memory that when executed by the processor, causes the processor to receive entitlement information of the device from an external computer, and to output the entitlement information in a form for user review.

21. The device recited in claim 20 further comprising: a panel to display information to a user; and the routine causes the processor further to output the device entitlement information to the panel.

22. The device recited in claim 20 embodied as a printing device, further comprising a printing unit for printing data; and the routine causes the processor to output the entitlement information to the printing unit.

23. The device recited in claim 20 wherein the external computer is a host computer for the device; and further comprising a port to couple the device to the host computer, wherein the port is to transmit both data representing a page to be printed by the printing device if the device is embodied as a printing device, or data representing a scan if the device is embodied as a scanning device; and to transmit the entitlement information.

24. The device recited in claim 20 further comprising a database to store current information of the entitlement information, and the routine causes the processor further to update the database with the received entitlement information.

25. The device recited in claim 24 wherein the database includes an identification of the device, and the routine causes the processor further to transmit the identification to the external computer.

26. The device recited in claim 25 further comprising a port to couple the device to the external computer, wherein the port is further to transmit the identification to the external computer.

27. The device recited in claim 20 wherein the entitlement information includes at least one of maintenance terms, warranty terms, maintenance contract expiration date, maintenance contract expiration date, available maintenance contracts, maintenance contact information, and warranty contact information.

28. The device recited in claim 20 wherein the external computer is a host computer for the device.

29. A system comprising the device recited in claim 28, the host computer, and a server to download the entitlement information to the host computer.

30. A server comprising:
a computer having at least one processor and memory;
the memory having stored thereon a routine and a database;
the database to store entitlement information associated with devices, said devices embodied as at least one of a printing devices and a scanning devices;
the routine when executed by the processor causes the server to:
receive a request for entitlement information associated with a device, the device characterized as at least one of printing device and a scanning device, the request being received from a requesting computer;
retrieve from the database any entitlement information associated with the device; and
download the entitlement information associated with the device to the requesting computer.

31. The server recited in claim 30 wherein the entitlement information contains new information since a previous download of the entitlement information.

32. The server recited in claim 30 wherein each entitlement information associated with a device in the database is associated with a first version identification, the request includes a second version identification, and the routine further causes the server to download only if the first version identification differs from the second version identification.

33. The server recited in claim 30 wherein the routine further causes the server to:
receive a request to update entitlement information in the database; and
update the database in accordance with the request.

34. The server recited in claim 30 wherein the entitlement data includes at least one of maintenance terms, warranty terms, maintenance contract expiration date, maintenance contract expiration date, available maintenance contracts, maintenance contact information, and warranty contact information.

35. A method comprising:
downloading entitlement information pertaining to a particular device, characterized as a particular printing device and/or a particular scanning device, from a remote server to a workstation; and
presenting the downloaded entitlement information to a user.

36. The method recited in claim 35 wherein the presenting includes sending the entitlement information to at least one of a computing device display, a panel of the device, and if the device is embodied as a printing device, to the printing device printing sheet.

37. The method recited in claim 35 wherein the workstation is embodied as a host computer to be coupled to the device.

38. The method recited in claim 35 further comprising at least one of automatically and manually requesting the downloading, wherein the downloading is in response to the requesting.

39. The method recited in claim 38 wherein the automatically requesting is at times specified by a human operator.

40. The method recited in claim 35 further comprising the workstation storing the entitlement information downloaded from the server on a workstation database.

41. The method recited in claim 35 further comprising downloading, from the workstation, entitlement information to the device.

42. The method recited in claim 35 wherein the entitlement information comprises at least one of device maintenance terms, device warranty terms, device maintenance contract expiration date, device maintenance contract expiration date, device available maintenance contracts, device maintenance contact information, and device warranty contact information.

43. The method recited in claim 35 further comprising generating a notification of updated device entitlement information.

44. The method recited in claim 35 further comprising generating a notification of entitlement expiration for the device.

45 A method executed at a printing device comprising: receiving updated entitlement information; and presenting the updated entitlement information to a human operator.

46. A method as recited in claim 45 wherein the presenting comprises displaying the updated entitlement information.

47. A method as recited in claim 45 wherein if the device is embodied as a printing device, the presenting comprises printing the updated entitlement information.

48. A method as recited in claim 45 wherein the entitlement information is received from a server that stores entitlement information for multiple devices.

49. A method as recited in claim 45 wherein the entitlement information comprises at least one of device maintenance terms, device warranty terms, device maintenance contract expiration date, device maintenance contract expiration date, device available maintenance contracts, device maintenance contact information, and device warranty contact information.

50. A method as recited in claim 45 wherein the entitlement information comprises a notification of entitlement expiration for the device.

51. A method comprising:
receiving, at a server a request from a device system, the device characterized as at least one of a printing device and a scanning device, for updated entitlement information for the device; and
in response to the request, downloading the updated entitlement information from the server to the device system.

52. The method recited in claim 51 further comprising:
receiving additional entitlement information associated with the device; and writing the additional entitlement information into a server database.

53. The method recited in claim 52 wherein the writing is dependent upon the inputting being made by an entity that is authorized to input the entitlement information to the server.

54. The method recited in claim 52 further comprising associating a version identifier with the additional entitlement information in the server database.

55. The method recited in claim 51 further comprising;
storing entitlement information for multiple devices; and
associating the entitlement information for that device according to a device identification.

56. The method recited in claim 55 further comprising downloading the updated entitlement information for the device according to the device identification associated with the device.

57. The method recited in claim 55 further comprising associating a version identifier with the entitlement information for the device.

58. The method recited in claim 51 wherein the downloading is conditioned upon whether the entitlement information for the device has been updated since a previous downloading of the entitlement information.
